(19) United States
(12) Patent Application Publication
(10) Pub. No.: US 2002/0113910 A1
(43) Pub. Date: Aug. 22, 2002

(54) Apparatus and method for controlling convergence in projection television

(75) Inventor: Il-hyun Ryu, Suwon-si (KR)

Correspondence Address: SUGHRUE, MION, ZINN, MACPEAK & SEAS, PLLC, 2100 Pennsylvania Avenue, N.W., Washington, DC, 20037-3202, US

(73) Assignee: SAMSUNG ELECTRONICS CO., LTD.

(21) Appl. No.: 09/986,691

(22) Filed: Nov. 9, 2001

(30) Foreign Application Priority Data
Feb. 16, 2001 (KR) 2001-7843

(51) Int. Cl. H04N 17/02; H04N 3/22

(52) U.S. Cl. 348/745; 348/190

(57) ABSTRACT

A convergence controlling apparatus and method, through which block scanning is performed to efficiently detect the output of an optical sensor before convergence control in a projection television. The apparatus includes a sensor provided at a predetermined position on the screen of the television for measuring the quantity of light sensed through the scanning of a predetermined video pattern; a pattern generator for generating a block pattern for scanning the surroundings of the sensor to determine a portion where the sensor is positioned and the video pattern for convergence control; and a convergence controller for controlling the convergence by controlling the scanning of the video pattern based on information on the position of the sensor, the information being detected using the block pattern generated by the pattern generator. Accordingly, the position of an optical sensor can be determined by the scanning of a block pattern before correcting a convergence using the scanning of a line pattern so that a lead time of the scanning of the line pattern can be minimized.

### BACKGROUND OF THE INVENTION

1. Field of the Invention

The present invention relates to an apparatus and method for operating a projection television, and more particularly, to a convergence controlling apparatus and method through which block scanning is performed to efficiently detect the output of an optical sensor before convergence control. The present application is based on Korean Patent Application No. 2001-7843 filed Feb. 16, 2001.

2. Description of the Related Art

Unlike common televisions, projection televisions have three cathode-ray tubes (CRTs) through which red (R), green (G) and blue (B) beams are separately projected, so it is necessary to control convergence of the R, G and B beams into focus to display an image. Even if this convergence control is completely accomplished when a projection television is manufactured, the current of a convergence yoke depends on the geomagnetic field existing at the location where the television is installed. Accordingly, it is practically impossible to maintain the convergence controlled state of the television after it is distributed.

### SUMMARY OF THE INVENTION

To solve the above problem, it is a first object of the present invention to provide a convergence controlling apparatus for detecting the position of an optical sensor using block scanning during convergence control, thereby minimizing the lead time of the convergence control.

It is a second object of the present invention to provide a convergence controlling method for detecting the position of an optical sensor using block scanning during convergence control, thereby minimizing the lead time of the convergence control.

Accordingly, to achieve the first object of the invention, there is provided an apparatus for controlling convergence in a television. The apparatus includes a sensing unit provided at a predetermined position on the screen of the television for measuring the quantity of light sensed through the scanning of a predetermined video pattern, a pattern generating unit for generating a block pattern for scanning the surroundings of the sensing unit to determine a portion where the sensing unit is positioned and the video pattern for convergence control, and a convergence control unit for controlling the convergence by controlling the scanning of the video pattern based on information on the position of the sensing unit, the information being detected using the block pattern generated by the pattern generation unit.

Preferably, the convergence control unit recognizes the position of the sensing unit, which is detected using the block pattern, as the center point of the screen and controls the scanning of the video pattern on the basis of the position.

To achieve the second object of the invention, there is provided a method of controlling convergence in a television, including the steps of (a) determining the position of a sensor, which is provided at a predetermined position on the screen of the television, through the scanning of a predetermined block pattern; and (b) controlling the scanning of a predetermined video pattern based on sensor position information which is obtained in the step (a) to control the convergence of the television.

Preferably, in the step (b), the position of the sensor which is detected using the block pattern is recognized as the center point of the screen, and the scanning of the video pattern is controlled on the basis of the position.

### BRIEF DESCRIPTION OF THE DRAWINGS

The above objects and advantages of the present invention will become more apparent by describing in detail a preferred embodiment thereof with reference to the attached drawings in which:

FIG. 1 is a block diagram of an apparatus for controlling the convergence of a projection television according to the present invention;

FIG. 2 is a diagram for explaining a method of controlling the convergence of a projection television according to the present invention; and

FIG. 3 is a diagram illustrating the result of detecting the position of a sensor using a block pattern.

### DETAILED DESCRIPTION OF THE PRESENT INVENTION

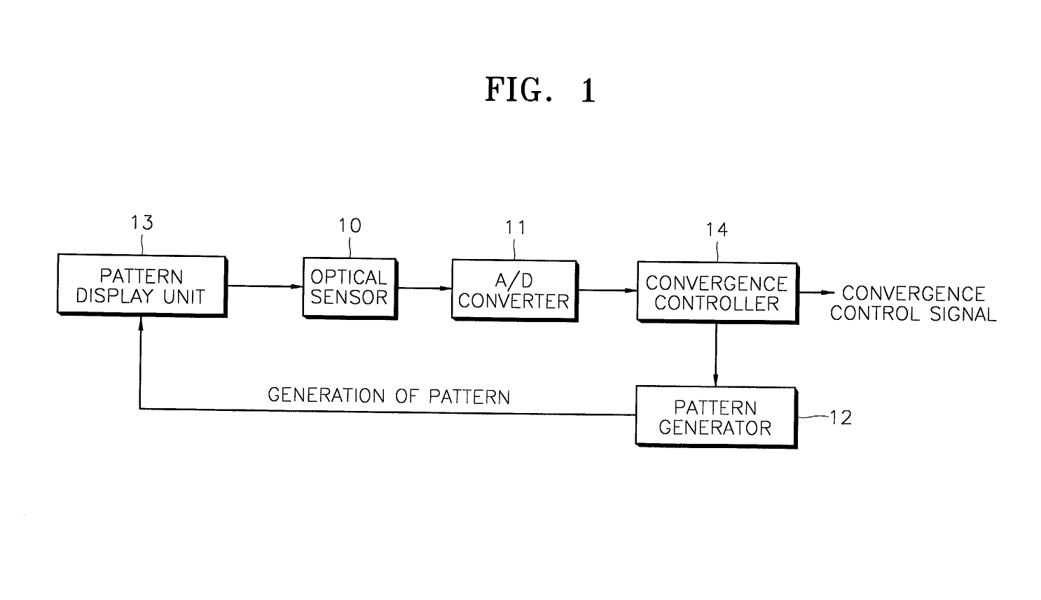

Referring to FIG. 1, an apparatus for controlling the convergence of a projection television includes an optical sensor 10 for sensing the quantity of light of each of the R, G and B light beams at a predetermined position in a visible ray region, an analog-to-digital (A/D) converter 11 for converting the output voltage of the optical sensor 10 into digital data, a pattern generator 12 for generating a line pattern (a video pattern) used for convergence control and a block pattern used for tracking the optical sensor 10, a pattern display unit 13 for displaying the block pattern and line pattern generated by the pattern generator 12, and a convergence controller 14 for adjusting convergence by controlling the scanning operation of the line pattern based on information on the position of the optical sensor 10, which is detected using the block pattern generated by the pattern generator 12.

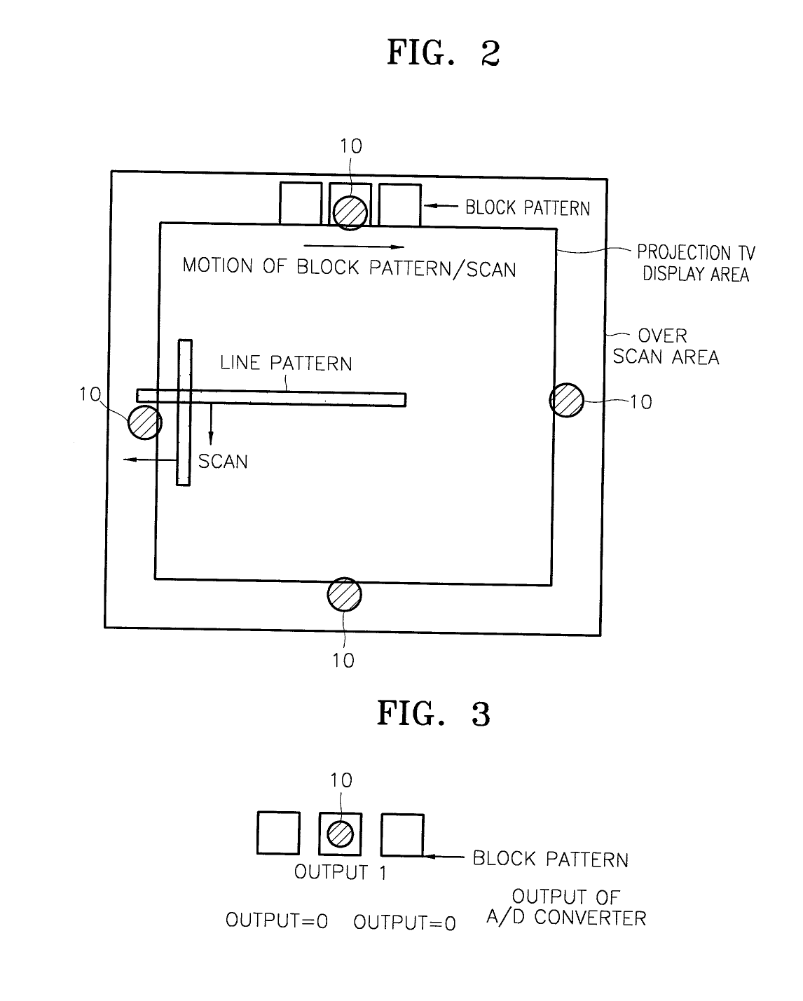

FIG. 2 is a diagram for explaining a method of controlling the convergence of a projection television according to the present invention. FIG. 3 is a diagram illustrating the result of detecting the position of the optical sensor using the block pattern. The present invention will be described in detail with reference to FIGS. 1 through 3.

The convergence controlling apparatus scans the screen of a projection television in an arbitrary line pattern, which is generated with respect to each of four optical sensors 10 positioned at the respective centers of four sides of the screen, recognizes a position where the output voltage of each optical sensor 10 is highest as the center point of the screen, reversely calculates a value for compensating for deviation from convergence due to a geomagnetic field, and adjusts the convergence on the basis of the center point recognized using the optical sensors 10. Here, the convergence controlling apparatus generates the arbitrary line pattern near the optical sensors 10 to scan the screen in horizontal and vertical directions in the line pattern to recognize the center point of the screen and the size thereof. However, it takes a long time to search for the center point using only the line pattern (scan time at a vertical frequency of 60 Hz=16.7 ms×the number of vertical lines in a scan area).

To overcome this problem, the line scan time can be reduced by scanning the vicinity of a sensor in a quadrilateral block pattern before the line scanning for detecting the center point and roughly determining a portion where the sensor is positioned based on the result of the block scanning.

As shown in FIG. 2, optical sensors 10 are positioned between a display area and an over scan area in a projection television. The number of optical sensors 10 is flexible. In this embodiment, it is assumed that four optical sensors 10 are provided at the respective centers of four sides of a projection television. Each of the optical sensors 10 senses the quantity of light of each of the R, G and B light beams at a predetermined position on the screen.

The pattern generator 12 generates a cross- or bar-shaped line pattern used for adjusting convergence and a quadrilateral block pattern used for tracking the optical sensors 10. The line pattern generated by the pattern generator 12 moves and scans in the horizontal and vertical directions of a projection television. The block pattern moves and scans around each of the optical sensors 10 positioned between the display area and the over scan area of the projection television. In other words, the block pattern should move to scan the portion between the display area and the over scan area in a clockwise or counterclockwise direction in order to detect the positions of the optical sensors 10. Like the number of optical sensors 10, the number of patterns generated by the pattern generator 12 is also flexible.

The A/D converter 11 converts the position of each optical sensor 10, which is detected by the scanning of the block pattern, and the quantity of light which is sensed by the scanning of the line pattern, into digital data. The optical sensor 10 is realized by a device such as a photo diode. The output of the optical sensor 10 is largest when the line pattern passes the median center of a photo diode light receiver. The maximum output corresponding to the maximum quantity of light sensed by the optical sensor 10 is converted into digital data by the A/D converter 11. In addition, the A/D converter 11 converts an output of the optical sensor 10, which is obtained when the block pattern scans the optical sensor 10, into digital data. The A/D converter 11 outputs the digital data, as shown in FIG. 3. The A/D converter 11 outputs a value of 1 when the block pattern scans the optical sensor 10 and a value of 0 when the block pattern scans a portion other than the optical sensor 10. The output value of the A/D converter 11 is input to the convergence controller 14.

The convergence controller 14 controls the scanning operation of the line pattern based on information on the position of the optical sensor 10, which is detected by the scanning operation of the block pattern. The convergence controller 14 can determine the position of the optical sensor 10 from the scan value of the block pattern received from the A/D converter 11. In other words, a portion where the output of the A/D converter is 1 is determined as the center point of the screen, and the scanning operation of the line pattern is controlled based on the determination. Due to the scanning of the block pattern, the time required to detect the center point and size of the screen by the scanning of the line pattern is reduced. The convergence controller 14 calculates the amount of deviation from convergence with respect to the center point of the screen which is detected using the block pattern and outputs a convergence compensation signal (a convergence yoke control signal).

According to the present invention, the position of an optical sensor can be determined by the scanning of a block pattern before correcting a convergence using the scanning of a line pattern so that a lead time of the scanning of the line pattern can be minimized.

Although the invention has been described with reference to a particular embodiment, it will be apparent to one of ordinary skill in the art that modifications to the described embodiment may be made without departing from the spirit and scope of the invention.

What is claimed is:

1. An apparatus for controlling convergence in a television, comprising:
sensing means provided at a predetermined position on the screen of the television for measuring a quantity of light sensed through scanning of a predetermined video pattern;
pattern generating means for generating a block pattern for scanning surroundings of the sensing means to determine a portion where the sensing means is positioned and the video pattern for convergence control; and
convergence control means for controlling the convergence by controlling the scanning of the video pattern based on information on the position of the sensing means, the information being detected using the block pattern generated by the pattern generation means.

2. The apparatus of claim 1, wherein the convergence control means recognizes the position of the sensing means, which is detected using the block pattern, as the center point of the screen and controls the scanning of the video pattern on the basis of the position.

3. A method of controlling convergence in a television, comprising the steps of:
(a) determining a position of a sensor, which is provided at a predetermined location on the screen of the television, through the scanning of a predetermined block pattern; and
(b) controlling the scanning of a predetermined video pattern based on sensor position information which is obtained in the step (a) to control the convergence of the television.

4. The method of claim 3, wherein in the step (b), the position of the sensor which is detected using the block pattern is recognized as the center point of the screen, and the scanning of the video pattern is controlled on the basis of the position.

5. An apparatus for controlling convergence in a television, comprising:
a pattern generator for generating a first predetermined pattern and a second predetermined pattern on a screen;
a sensor provided at a location on the screen for sensing a quantity of light caused by the first predetermined pattern and the second predetermined pattern and for outputting a signal corresponding to the quantity of light sensed; and
a convergence controller for receiving the signal output by the sensor, wherein said pattern generator scans the first predetermined pattern in an area around said sensor, and said convergence controller determines location information of the sensor based on the signal output by the sensor when said pattern generator scans the first predetermined pattern, controls scanning of the second predetermined pattern based on the location information, and controls convergence based on the scanning of the second predetermined pattern.

6. The apparatus of claim 5, wherein the convergence controller uses the location information to recognize the location of the sensor as a center point of the screen and determines an amount of deviation from convergence with respect to the center point of the screen and outputs a convergence compensation signal based on the amount of deviation.

7. The apparatus of claim 5, wherein the first predetermined pattern is a block pattern and the second predetermined pattern is a line pattern.

8. A method of controlling convergence in a television, comprising steps of:
generating a first predetermined pattern and a second predetermined pattern on a screen;
using a sensor provided at a location on the screen to sense a quantity of light caused by the first predetermined pattern and the second predetermined pattern and outputting a signal corresponding to the quantity of light sensed;
receiving the signal output by the sensor;
scanning the first predetermined pattern in an area around the sensor;
determining location information of the sensor based on the signal output by the sensor when scanning the first predetermined pattern;
controlling scanning of the second predetermined pattern based on the location information; and
controlling convergence based on the scanning of the second predetermined pattern.

9. The method of claim 8, wherein the controlling convergence step comprises:
using the location information to recognize the location of the sensor as a center point of the screen;
determining an amount of deviation from convergence with respect to the center point of the screen;
and outputting a convergence compensation signal based on the amount of deviation.

10. The method of claim 8, wherein the first predetermined pattern is a block pattern and the second predetermined pattern is a line pattern.
